(19) United States
(12) Patent Application Publication
(10) Pub. No.: US 2016/0071378 A1
(43) Pub. Date: Mar. 10, 2016

(54) INFORMATIVE OBJECT

(71) Applicant: Ripple Effect Co., Ltd., Nishinomiya City (JP)

(72) Inventor: Junya Mokubo, Hyogo (JP)

(21) Appl. No.: 14/828,069

(22) Filed: Aug. 17, 2015

(30) Foreign Application Priority Data
Aug. 18, 2014 (JP) 2014-180630

(51) Int. Cl. G08B 5/24; G08B 5/36

(52) U.S. Cl. CPC G08B 5/24; G08B 5/36

(57) ABSTRACT

An informative object for constantly observing the state and change of information in everyday life is provided. The informative object expresses information based on changes in shape and light formed by a seesaw 10 as a tilt mobile object having a variable tilt angle relative to a horizontal plane, a sphere 20 that rolls by gravity on the upper surface of the seesaw 10, and an LED light source 13 incorporated in the tilt mobile object.

### BACKGROUND OF THE INVENTION

1. Field of the Invention

The present invention relates to an informative object whose shape and lighting are variable.

2. Background Art

A wide variety of information has been conventionally provided through screen display of electronic information terminals such as personal computers, smartphones, and equipment dedicated to each application.

### SUMMARY OF THE INVENTION

In such a situation, the following problems arise:

(a) Although such a conventional electronic information terminal is useful for a user to read predetermined information actively, recognition of the information depends on the activeness of the user. Thus, the electronic information terminal is not practical for constantly observing predetermined information in everyday life and obtaining an overall view of tendencies thereof;

(b) A conceivable means for solving the problem (a) is to inform a user of a change in the state of information with, for example, an e-mail. However, frequent notifications interrupt thinking and behavior and gradually become burdensome for the user. Accordingly, the notifications are often disregarded, resulting in failures in information transmission in many cases;

(c) Information is often expressed in the form of characters and figures on a screen. Visual impressions thereof on a reader tend to be uniform, and the amount of information tends to be excessive. Thus, it is difficult for a user to know a summary of information intuitively in a short time; and

(d) As another attempt, a terminal is provided with a light-emitting object so as to notify a user of a state or change of information by using the way of lighting or the color of light as a trigger in everyday life. The way of lighting and the color of light, however, are not suitable for displaying quantitative information and the tendency thereof. Thus, the expressiveness in this attempt is restrictive. In addition, the content of information that can be transmitted to the user is limited to prepared information, and the attempt cannot cope with the current situation where new information is consecutively provided through the Internet.

The present invention provides an informative object whose shape and light are variable in accordance with information obtained through a Web API on the Internet or information obtained from a local environment, and which serves as a contact with everyday life in interior decoration.

The informative object of the present invention provides an opportunity of seeing information whose state and change are to be noticed as part of daily scene, enables a user to intuitively know the volume and tendency of the information, and promotes realization and overall understanding of the information through continuous observation in everyday life. The informative object of the present invention is not limited to specific information and information service, and can deal with a variety of information and be used to consider a correlation between different types of information.

### BRIEF DESCRIPTION OF THE DRAWINGS

FIG. 1 is a front perspective view of an informative object 1.

FIG. 2 is a front view of the informative object 1.

FIG. 3 is a top view of the informative object 1.

FIG. 4 is a partial cross-sectional view of the informative object 1.

FIG. 5 is a view illustrating an example in which the seesaw 10 of the informative object 1 tilts.

FIG. 6 illustrates a change of the shape of the informative object 1.

FIG. 7 illustrates how the informative object 1 refers to external information.

FIG. 8 is a flow chart from information acquisition to movement of the informative object 1.

FIG. 9 illustrates an example of blinking of a sphere 20.

### DESCRIPTION OF THE PREFERRED EMBODIMENTS

An informative object according to an embodiment of the present invention will be described with reference to the drawings.

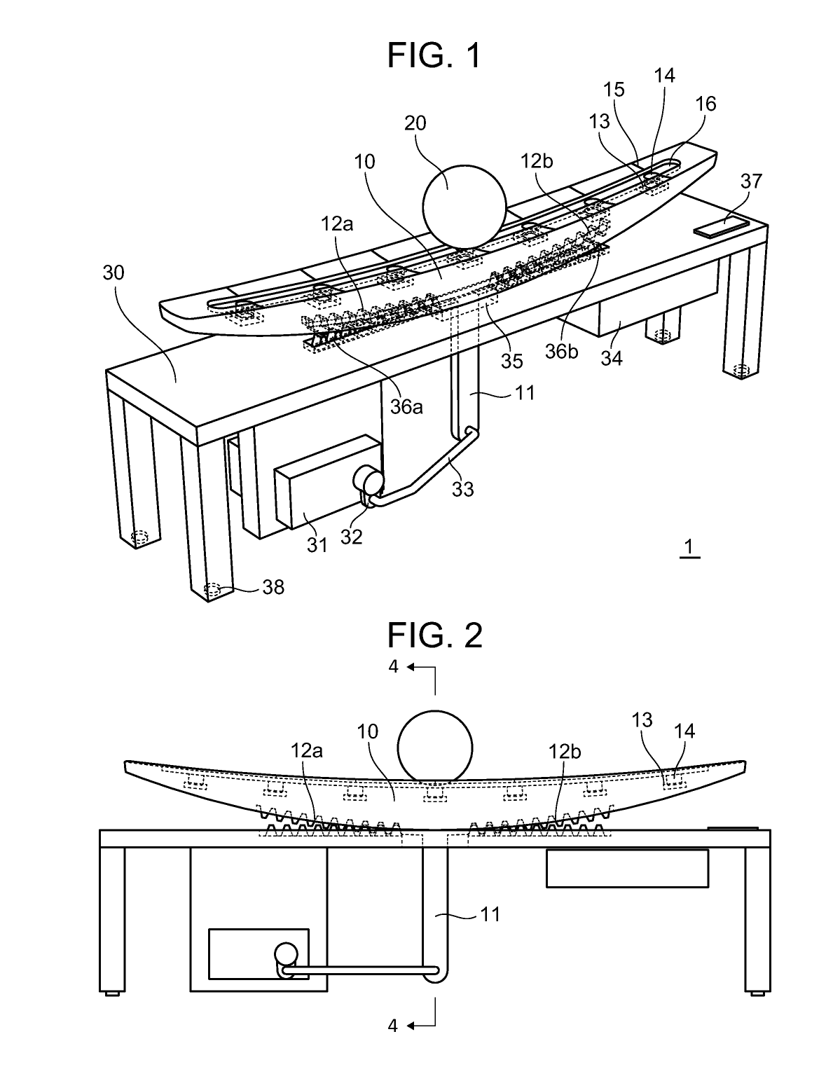

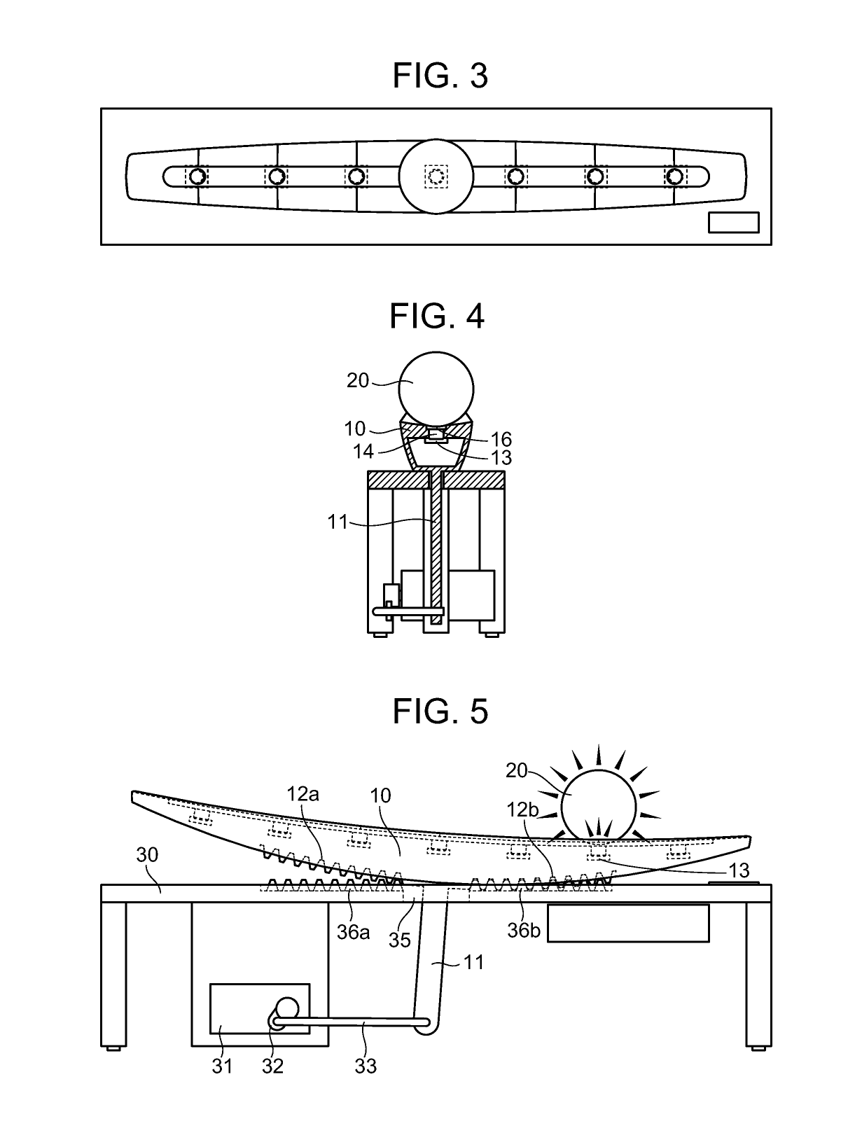

FIG. 1 is a front perspective view illustrating an informative object 1. The informative object 1 includes: a seesaw 10 that is a tilt mobile object whose tilt angle is adjustable to a predetermined angle relative to a horizontal plane; a translucent white sphere 20 that rolls sideways by gravity on an upper surface of the seesaw 10; and a base 30 supporting the bottom surface of the seesaw 10.

In an actual display of the informative object 1, the internal mechanism is preferably concealed in terms of design by, for example, enclosing the exterior of the base 30 with a decorative laminate. Since the informative object 1 is not necessarily placed on a completely horizontal plane, an adjusting function such as adjusters 38 attached to the legs of the base 30 needs to be prepared.

FIG. 2 is a front view of the informative object 1. The bottom surface of the seesaw 10 is arc-shaped and provided with a flat bar 11 vertically extending from the center of the bottom surface. Arc-shaped gears 12a and 12b are respectively provided at the left and right of the flat bar 11 and extend along the shape of the bottom surface of the seesaw 10.

The seesaw 10 is hollow and includes an odd-numbered LED light sources 13 constituted by LEDs of three colors: red, blue, and green. The LED light sources 13 are arranged along the upper surface of the seesaw 10 and evenly spaced from one another. Openings 14 through which light passes upward from the LED light sources 13 are formed in the upper surface of the seesaw 10 at positions corresponding to the LED light sources 13.

The upper surface of the seesaw 10 is substantially arc-shaped and has slightly recessed portions 15 around the openings 14 as illustrated in FIG. 1, thereby causing the sphere 20 to stop immediately above the openings 14.

FIG. 4 is a partial cross-sectional view of the informative object 1 taken along line 4-4 in FIG. 2. The seesaw 10 has a concave cross-sectional shape such that the sphere 20 rolling on the upper surface of the seesaw 10 does not fall away. The seesaw 10 also has a groove 16 along the center, and the openings 14 are positioned in the bottom surface of the groove 16 such that the openings 14 do not affect rolling of the sphere, thereby causing the sphere 20 to roll smoothly along the upper rim of the groove 16.

FIG. 5 is a front view illustrating an example in which the seesaw 10 of the informative object 1 tilts. The upper surface of the base 30 has a slit 35 which is large enough to allow the flat bar 11 of the seesaw to penetrate therethrough and swing sideways therein. The upper surface of the base 30 is provided with linear gears 36a and 36b extending along the upper surface of the base 30 at the left and right of the slit 35. These gears 36a and 36b are vertically engaged with the gears 12a and 12b of the seesaw such that the seesaw 10 tilts sideways without lateral and vertical shifts of the positional relationship between the seesaw 10 and the base 30.

A link 33 is provided to couple a servo horn 32 of a servo motor 31 fixed to the base 30 and the flat bar 11 of the seesaw. The shaft of the servo motor 31 is rotated to a predetermined angle so that the flat bar 11 of the seesaw is pushed and pulled through the servo horn 32 and the link 33 and, thereby, the seesaw 10 tilts at a predetermined angle.

When the seesaw 10 tilts, the sphere 20 rolls by gravity and stops at a lowest position on the upper surface of the seesaw 10, one of the LED light sources 13 immediately below the sphere 20 emits light, and the sphere 20 glows under the influence of the emitted light.

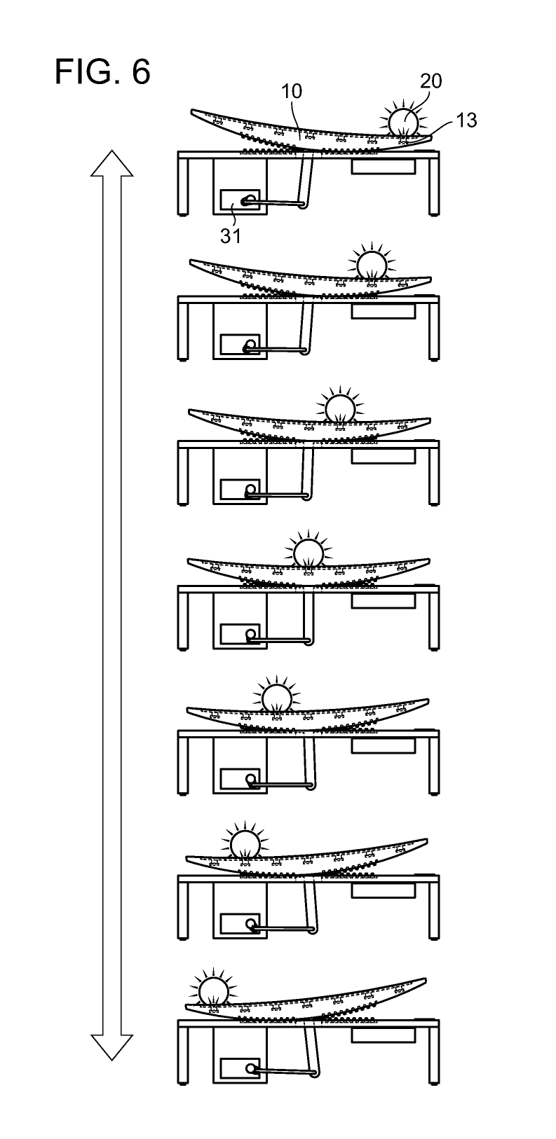

FIG. 6 illustrates an example in which the servo motor 31 rotates to a predetermined angle so that the seesaw 10 laterally tilts at a predetermined angle, and then, the sphere 20 rolls accordingly and stops at a different position, thereby changing the shape of the object. The LED light source 13 immediately below the sphere at each position emits light, and the sphere 20 glows under the influence of the emitted light.

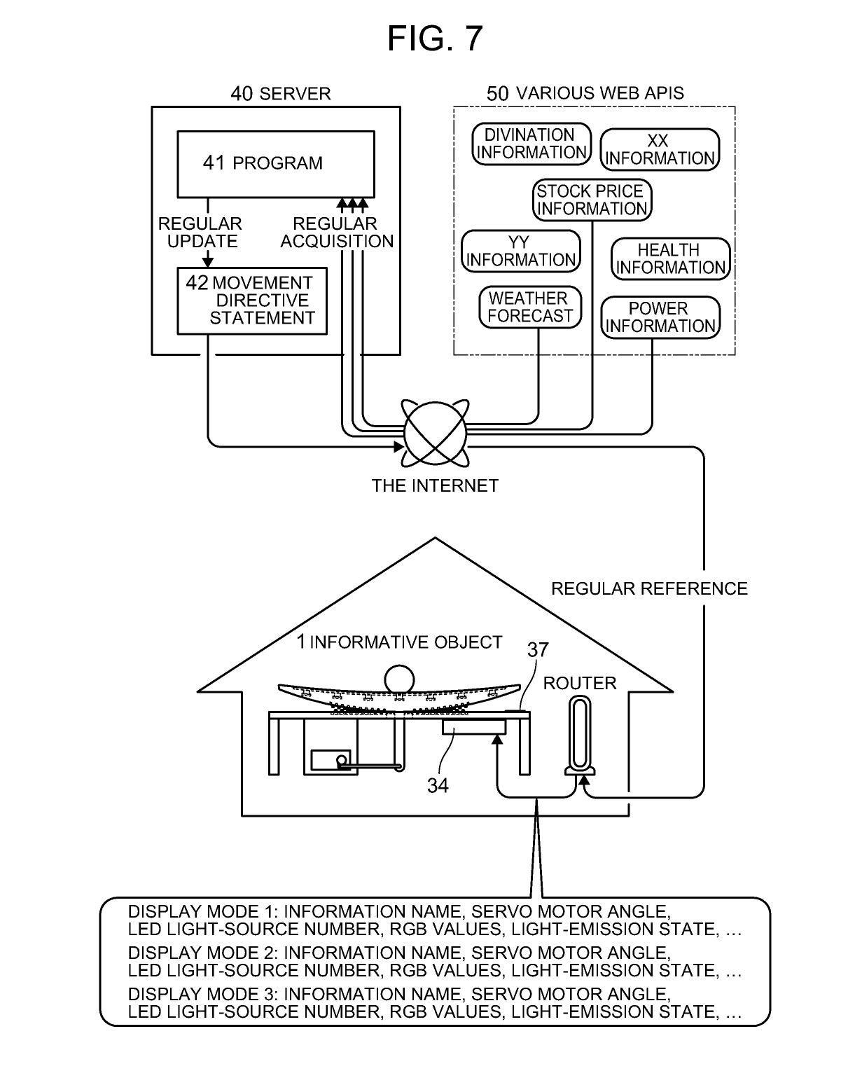

FIG. 7 illustrates that the informative object 1 regularly refers to a movement directive statement 42 in a predetermined server 40 on the Internet. The predetermined server 40 includes a program 41 for regularly acquiring predetermined information from various Web APIs 50 published on the Internet and regularly updating the movement directive statement 42 based on the acquired information.

The program 41 defines information to be acquired, a Web API for acquiring the information, the interval for acquiring the information, the way of evaluating the acquired information, and how to determine movement of the informative object 1. Results of the determination are described in the movement directive statement 42, which is regularly updated.

The movement directive statement 42 has display modes in the number corresponding to the types of information to be displayed. Specifically, for example, a display mode 1 indicates a “power balance” and a display mode 2 indicates a “stock price.” Movement directives of the informative object 1 are described in order after the name of information.

Specifically, the program 41 described in, for example, a PHP language requests power information of home from electric information API minutely, acquires information as data in an XML format, parses the XML data, extracts the values of generated power and consumed power, and then evaluates the values in the following seven stages:
(a) a case where generated power exceeds consumed power by 25 Wh or more;
(b) a case where generated power exceeds consumed power by 15 Wh or more and less than 25 Wh;
(c) a case where generated power exceeds consumed power by 5 Wh or more and less than 15 Wh;
(d) a case where the difference between generated power and consumed power is less than 5 Wh;
(e) a case where generated power is below consumed power by 5 Wh or more and less than 15 Wh;
(f) a case where generated power is below consumed power by 15 Wh or more and less than 25 Wh; and
(g) a case where generated power is below consumed power by 25 Wh or more.

Movement of the informative object 1 is determined depending on the information evaluation such that the angle of the servo motor 31 is 20 degrees and the first LED light source 13 is always on with rgb values of 0, 0, and 255 (blue) in the case (a), the angle of the servo motor 31 is 90 degrees and the fourth LED light source 13 is always on with rgb values 0, 255, and 0 (green) in the case (d), the angle of the servo motor 31 is 160 degrees and the seventh LED light source 13 is always on with rgb values 255, 0, and 0 (red) in the case (g), for example. Results of this determination are described in the movement directive statement 42. The content of the description is preferably encrypted for information security.

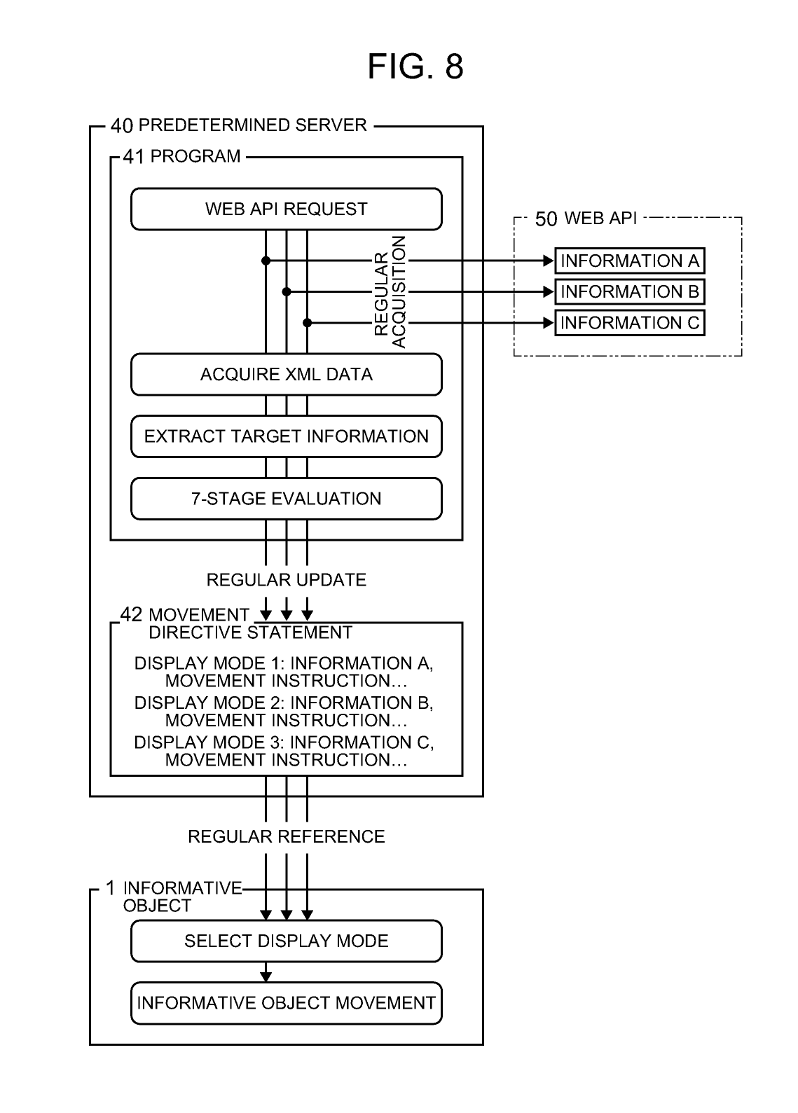

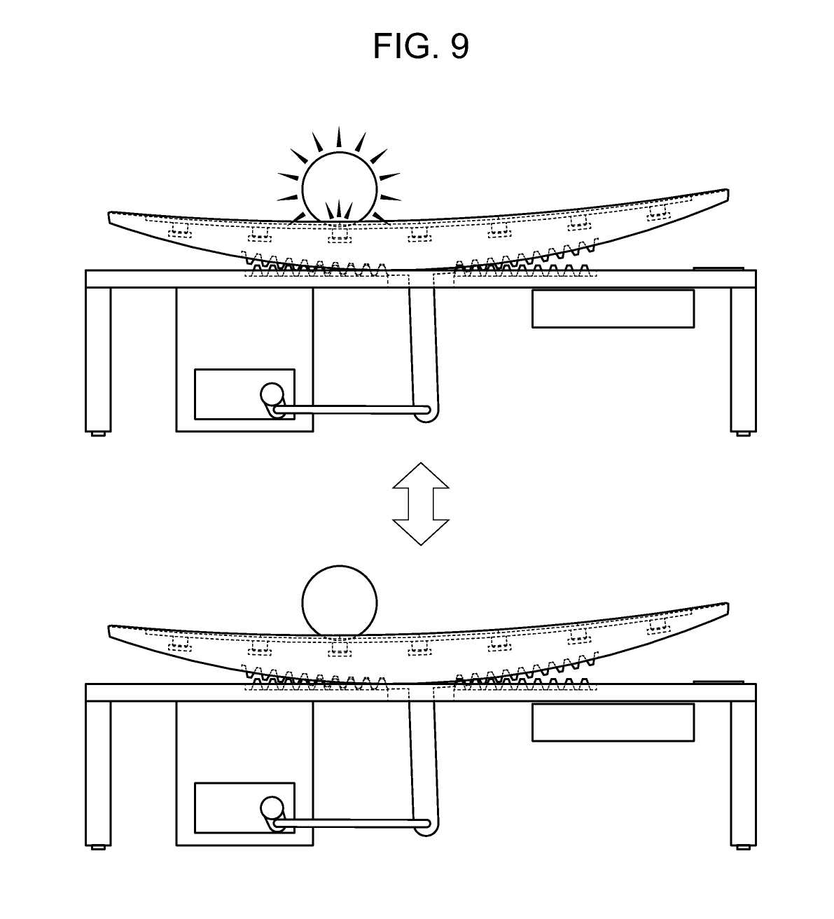

A microcomputer 34 of the informative object 1 regularly refers to the movement directive statement 42 in the predetermined server 40, and determines movement depending on the content of the description and a current display mode. FIG. 8 is a flow chart from information acquisition to movement of the informative object 1.

The display mode can be switched by pressing a switch 37 on the upper surface of the base. To notify a user of information that is being displayed, an utterance IC and a speaker are added to, for example, the microcomputer 34 such that the name of information, e.g., “power balance,” is uttered when the button is pressed. Since the informative object 1 can express various types of information, it is important to design the informative object 1 so as to flexibly cope with a change of the way of issuing a notice of the name of information.

The microcomputer 34 of the informative object 1 does not directly refer to the Web API 50 for the following reasons:

(a) To obtain flexibility in remotely determining the content of information expressed by the informative object 1 and the way of expressing the information by changing the program 41. This case has an operational advantage that a provider of the informative object 1 and a provider of information to the informative object can remotely determine the setting even if a user of the informative object 1 has no knowledge of the program.

(b) Parsing of XML data, for example, applies a heavy load on such a small microcomputer 34 as installed in the informative object 1.

The informative object 1 may move based on information acquired in a local environment. This mechanism is similar to that described above except for the following aspects, and thus, will not be described again.

(c) Using, for example, a measured value of a sensor in the local environment, instead of the Web API 50;

(d) Regularly referring to (a) and placing a program of regularly updating a movement directive statement and the generated movement directive statement in the local environment; and

(e) The microcomputer 34 of the informative object 1 regularly refers to a movement directive statement in the local environment.

In the foregoing embodiment, preferred examples of the present invention have been described. However, mechanisms for implementation are not limited as long as the seesaw 10 can be accurately tilted at a predetermined angle relative to the horizontal plane by using, for example, attraction and repulsion of electromagnets. Examples of Application of Present Invention

The present invention is applicable to a home energy management system (HEMS). As described above, cooperation with the informative object of the present invention can be obtained by using a Web API for enabling reference to home power information. For a user having a photovoltaic power generation system at home, the informative object of the present invention can serve as a display unit that can intuitively indicate a power balance between generation and consumption. The informative object can offer pleasure of generating electricity at home with the photovoltaic power generation system and suggest a better way of using electricity. If a user notifies that the seesaw slightly tilts to the left, i.e., indicates power purchase, the user will be inclined to return the seesaw to neutral or the right by saving power consumption in some way.

A synergistic effect with a conventional terminal can be expected when a user uses a personal computer or a smartphone in order to obtain more specific information from awareness obtained with the informative object of the present invention.

As illustrated in FIG. 9, a notification of a power saving request from a local power supplier may be issued by using blinking of the sphere. There is a mechanism called demand response in which when serious shortage of a local power supply is expected, a power supplier requests an active power saving to households and companies, and in response to this, offers an incentive in accordance with the amount of achieved power saving. The informative object of the present invention can be expected as a terminal for promoting such activities.

The informative object of the present invention can be used as a health care monitor. With a currently widespread use of wearable terminals, environments that enable constant measurement of various types of information such as a heart rate, a blood pressure, a body temperature, a footstep count, an active mass, and a sleeping hour have become widespread. These types of information are expected to be provided with Web APIs, and thus, cooperation with the informative object of the present invention can be obtained. The informative object of the present invention is useful for knowing health status of a user himself/herself, a family member living in the same household, and a parent living in a remote place. A health status estimated from acquired health information is indicated by a tilt of the seesaw or blinking of the sphere can notify the user of a possible necessity of a diagnosis or a safety confirmation.

The informative object of the present invention can be used as a stock price monitor. Indexes of general economic indicators such as stock prices for each stock and Nikkei average stock prices are provided with Web APIs, and cooperation with the informative object of the present invention can be obtained. Specifically, the tilt of the seesaw allows a user to intuitively know the degree of change in the stock price of a stock the user has, as compared to the acquisition cost, and whether the change is currently in an increasing trend or a decreasing trend, and constantly feel the economic trend in everyday life. In addition, when the stock price of the stock the user has reaches the par, notification of this can be issued by blinking of the sphere.

In other applications, cooperation with the informative object of the present invention can be obtained by using the informative object of the present invention as a daily fortune monitor with a Web API for astrology or a weather forecast monitor with a weather forecast API as long as information provided with Web APIs are used.

In the foregoing examples, only one type of information is expressed at a time. Alternatively, a correlation between two different types of information can be continuously observed in everyday life by expressing individual types of information, e.g., an atmospheric pressure and a health status, by using the tilt angle of the seesaw and the color tone of the sphere. Alternatively, the informative object of the present invention can serve as a current mirror in such a manner that a correlation between the content issued in an SNS and an economic indicator in the Nikkei average stock price, for example.

The present invention is applicable to information display terminals and information service businesses.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

1. An informative object comprising:
a tilt mobile object having a variable tilt angle relative to a horizontal plane; and
a sphere that rolls on an upper surface of the tilt mobile object, wherein
the tilt angle of a tilt mobile object is changed to a predetermined angle in accordance with information acquired from outside such that information is expressed based on a change in shape formed by the tilt mobile object and the sphere.

2. The informative object of claim 1, wherein
the tilt mobile object includes a light-emitting element such that information is expressed based on the change in shape and a change of light formed by the tilt mobile object and the sphere.

3. The informative object of claim 1, wherein
the informative object moves based on information acquired by using a Web API on the Internet or information acquired in a local environment.

4. The informative object of claim 2, wherein
the informative object moves based on information acquired by using a Web API on the Internet or information acquired in a local environment.
